(19) United States
(12) Patent Application Publication
(10) Pub. No.: US 2009/0225638 A1
(43) Pub. Date: Sep. 10, 2009

(54) RECORDING SYSTEM HAVING IMPROVED PREPIT DETECTION

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,534

(22) PCT Filed: Jun. 14, 2005
(86) PCT No.: PCT/IB05/51960

§ 371 Date: Dec. 13, 2006

(30) Foreign Application Priority Data
Jun. 22, 2004 (EP) 04102881.2

(51) Int. Cl. G11B 20/00

(52) U.S. Cl. 369/47.15; G9B/20

(57) ABSTRACT

A recording device records marks in a track on a record carrier via a beam of radiation. The record carrier has a preformed track pattern such as a wobbled pregroove having prepits for encoding record carrier information. The device has a head for generating a scanning spot on the track and a front-end unit coupled to the head for generating detector signals based on radiation reflected from the track, the detector signals including a left subdetector signal and a right sub-detector signal. The device has a demodulation unit for retrieving the record carrier information from the detector signals, which includes a radial modulation signal circuit (34). The circuit generates a radial modulation signal (66) based on a difference signal of the sub-detector signals (61,62) normalized by a sum signal of the sub detector signals, and generates the sum signal by adding a correction amount. Thereby overcompensation due to normalization is reduced.

The invention relates to a device for recording information on a record carrier via a beam of radiation, the information being represented by marks in a track, the record carrier having a preformed track pattern for indicating the track, the preformed track pattern including a radial modulation pattern for encoding record carrier information, the device comprising a control unit for controlling the recording, and a head for providing the beam of radiation for generating a scanning spot on the track.

The invention further relates to a method of generating a radial modulation signal from a track on a record carrier, the track comprising marks representing information, the record carrier having a preformed track pattern for indicating the track, the preformed track pattern including a radial modulation pattern for encoding record carrier information.

U.S. Pat. No. 4,901,300 describes a recording device for writing marks in a track on a record carrier of a recordable type. The optical recording device is equipped with a head to focus a beam of light into a scanning spot on a track on a recording layer of the record carrier. The head is radially positioned on the track via a servo system based on a radial error signal. The record carrier is provided with a preformed track pattern to indicate the position of the track, e.g. a pregroove. The pregroove is modulated by a wobble that can be detected via a radial modulation signal, for example based on sub-detector signals such as a left sub-detector signal and a right sub-detector signal. A differential radial detector signal, usually called push-pull signal, can be used to detect a radial positioning error of the spot with respect to the center of the track. The modulation of the pregroove is detected from the radial modulation signal based on sub-detector signals. A combined detector signal, usually called sum signal or central aperture signal, may be generated for detecting the marks based thereon.

Nowadays high density optical disc systems are available such as the digital versatile disc (DVD) system. A recordable DVD is provided with a preformed track pattern that is radially modulated for encoding record carrier information, such as addresses and record carrier recording parameters, for example recording power, type of layers, size of the recordable area, etc. In a particular example called DVD-RW (a DVD rewritable recording standard), the radial modulation pattern is embodied by a monotone wobble of the pregroove in combination with local variations in height of the land area (left or right) adjacent to the pregroove, so called prepits. The radial modulation is detected from sub-detector signals as described above. The prepits are detected and record carrier information is decoded thereof before writing marks to the respective part of the track. However, when marks have been recorded in a part of the track, the sub-detector signals are severely affected by the presence of the marks. Prior art recording devices retrieve the prepit information of a part of the track when no marks are recorded. After recording marks such devices rely on the recorded marks to read addresses and record carrier information.

Therefore it is an object of the invention to provide a recording device and method for generating of a reliable radial modulation signal less affected by the presence of recorded marks.

According to a first aspect of the invention the object is achieved with a recording device as defined in the opening paragraph, which device comprises a front-end unit coupled to the head for generating detector signals based on radiation reflected from the track, the detector signals including a left sub-detector signal and a right sub-detector signal based on the radiation as reflected from a left and right side of the track respectively, and demodulation means for retrieving the record carrier information from the detector signals, the demodulation means comprising radial modulation signal means for generating a radial modulation signal based on a difference signal of the sub-detector signals normalized by a sum signal of the sub-detector signals, and for generating the sum signal by adding a first correction amount.

According to a second aspect of the invention the object is achieved with a method as defined in the opening paragraph which method comprises generating detector signals based on radiation reflected from the track, the detector signals including a left sub-detector signal and a right sub-detector signal based on the radiation as reflected from a left and right side of the track respectively, and retrieving the record carrier information from the detector signals by generating a radial modulation signal based on a difference of the sub-detector signals normalized by a sum of the sub-detector signals, and for generating the sum by adding a first correction amount.

The measures have the effect of compensating the influence of marks on the radial modulation signal. If the scanning spot is at a location of the track that contains a mark, the detector signals will be affected. However, the effect of marks on the radial modulation signal, based on a difference signal of the sub-detectors, is disturbing the detection of the radial modulation pattern that encodes the record carrier information. The influence of the marks is substantially compensated by the normalization of the difference signal by the sum signal, e.g. dividing the difference signal by the sum signal. The amount of compensation is adjusted by the correction value. This has the advantage that the effect of the marks is substantially reduced.

The invention is also based on the following recognition. Basically the pregroove and the record carrier information encoded in the radial modulation pattern are intended for use during recording a virgin track. After marks have been recorded, such marks can easily be read and used to retrieve addresses and other recording information. However, the inventors have seen that in high density optical recording it is preferred to retrieve the record carrier information from the radial modulation pattern even after marks have been recorded in the track. Specifically, in areas that alternatingly contain virgin and written blocks, it is very convenient to use the radial modulation signal for the entire area. Hence any inaccuracies from the original recording will not be copied if new recordings are made in the same part of the track. However, the radial modulation pattern was originally not intended to be detected in the presence of marks, and the radial modulation signals are severely deteriorated. Due to the circuits of the invention the radial modulation signal is substantially improved by normalization using the sum signal to indicate the amount of radiation reflected from the track. In addition, the inventors have seen that the deterioration is structurally dependent on the shapes of the radial modulation pattern, e.g. the prepits in DVD-RW, and the marks written in the track. Hence the deviation of the signal is predictable, and therefore can be compensated by a suitable correction. A reliable radial modulation signal is reconstructed by normalization and further improved by the correction amount.

In an embodiment of the device the radial modulation signal means is arranged for generating the difference signal by adding a second correction amount. The effect of adding the second correction amount to the difference signal allows a further compensation of the effects of marks. This has the advantage that the radial modulation signal is more reliable.

In an embodiment of the device the radial modulation signal means is arranged for said normalizing by dividing the sum signal by the difference signal. Although normalizing could be achieved in various ways, such as controlling a gain, in a practical embodiment normalization is performed by dividing. This has the advantage that suitable circuits can be created in hardware.

In an embodiment of the device the control unit is arranged for setting the first and/or second correction value based on a measurement of signals from the record carrier. By performing a setup measurement after inserting a record carrier a suitable value for the correction amount is determined. This has the advantage that variation of the radial modulation signal due to individual record carrier properties and aging are automatically compensated.

Further preferred embodiments of the device and method according to the invention are given in the appended claims, disclosure of which is incorporated herein by reference.

These and other aspects of the invention will be apparent from and elucidated further with reference to the embodiments described by way of example in the following description and with reference to the accompanying drawings, in which

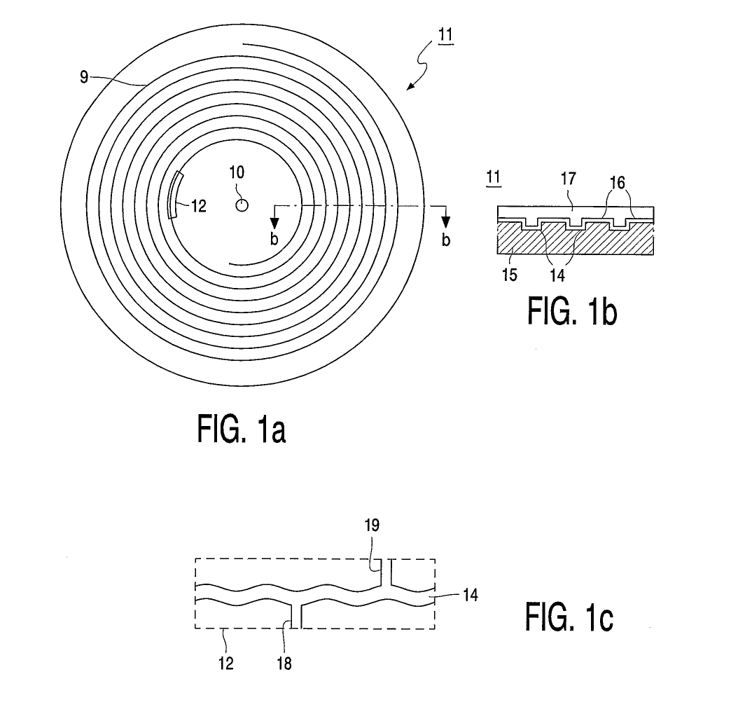

FIG. 1a shows a disc-shaped record carrier,

FIG. 1b shows a cross-section taken of the record carrier,

FIG. 1c shows a wobble of the track and prepits,

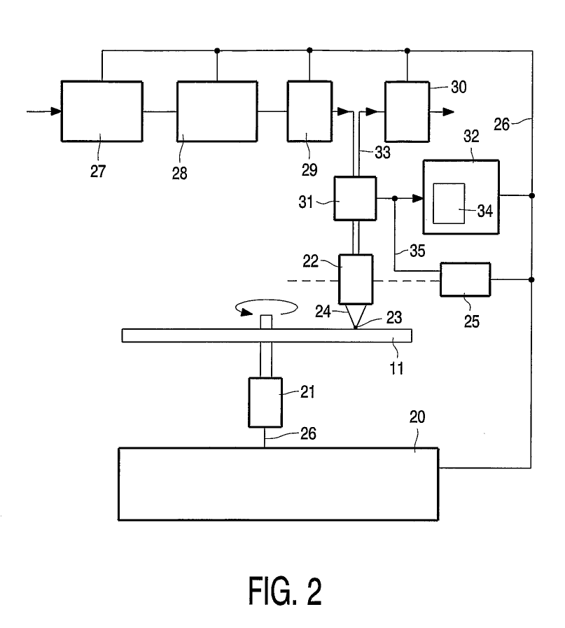

FIG. 2 shows a recording device having prepit detection,

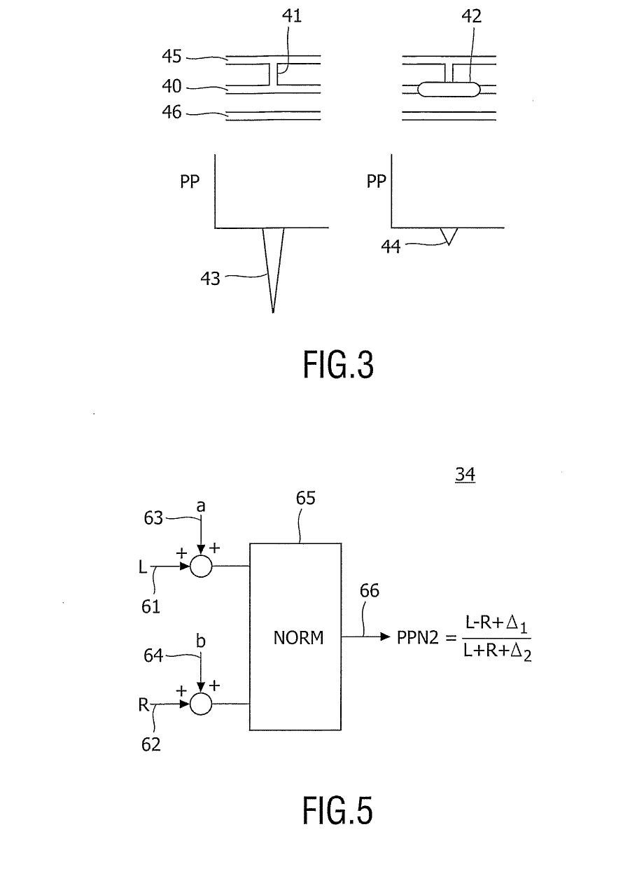

FIG. 3 shows a radial modulation signal at a prepit,

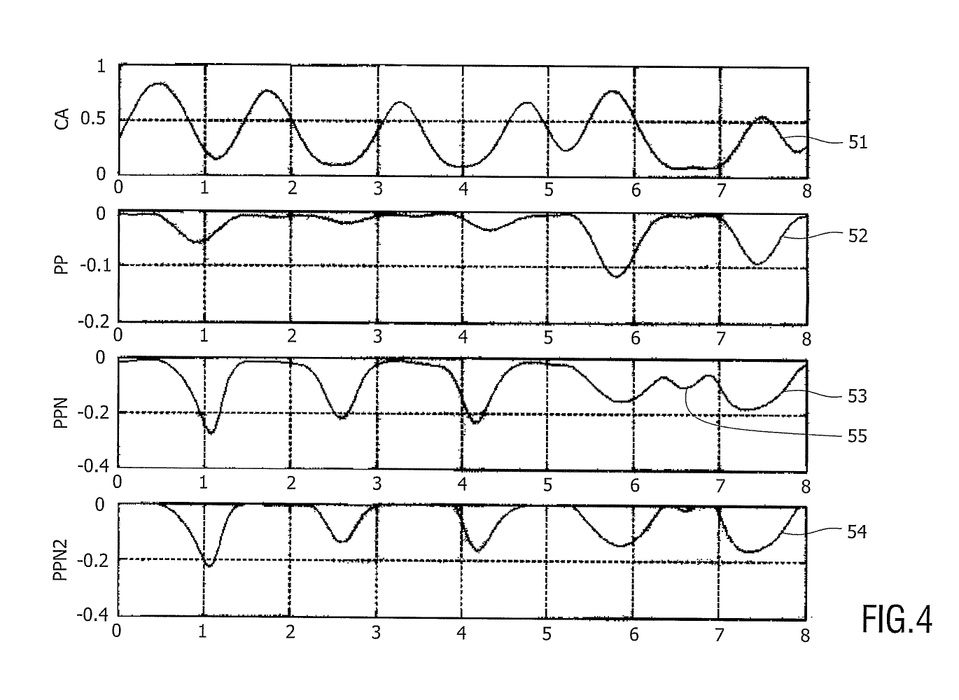

FIG. 4 shows a radial modulation signal in a written area, and

FIG. 5 shows a circuit for generating a radial modulation signal.

In the Figures, elements which correspond to elements already described have the same reference numerals.

FIG. 1a shows a disc-shaped record carrier 11 having a track 9 and a central hole 10. The track 9 is arranged in accordance with a spiral pattern of turns constituting substantially parallel tracks on an information layer. The record carrier may be an optical disc having an information layer of a recordable type. Examples of a recordable disc are the CD-R and CD-RW, and the DVD-RW or DVD+RW. The track 9 on the recordable type of record carrier is indicated by a pre-embossed track structure provided during manufacture of the blank record carrier, for example a pregroove. A cross-section is shown in FIG. 1b, and a detail 12 is shown in FIG. 1c. Recorded information is represented on the information layer by optically detectable marks recorded along the track. The marks are constituted by variations of a physical parameter and thereby have different optical properties than their surroundings, e.g. variations in reflection.

FIG. 1b is a cross-section taken along the line b-b of the record carrier 11 of the recordable type, in which a transparent substrate 15 is provided with a recording layer 16 and a protective layer 17. The track structure is constituted, for example, by a pregroove 14 which enables a read/write head to follow the track 9 during scanning. The pregroove 14 may be implemented as an indentation or an elevation, or may consist of a material having a different optical property than the material of the pregroove. The pregroove enables a read/write head to follow the track 9 during scanning. A track structure may also be formed by regularly spread sub-tracks which periodically cause servo signals to occur. The record carrier may be intended to carry real-time information, for example video or audio information, or other information, such as computer data.

FIG. 1c shows a wobble of the track and prepits as an example of radial modulation of the track pattern. The Figure shows in a detail 12 of the track 9 a periodic variation of the lateral position of the pregroove 14, also called a wobble. The variations cause an additional signal to arise in auxiliary detectors, which is called a radial modulation signal, e.g. a push-pull signal generated by sub-detectors in the central spot in a head of a scanning device. The wobble is, for example, frequency modulated and position information is encoded in the modulation. In a particular embodiment the pregroove comprises a modulation for transferring control data relating to the recording parameters of the record carrier to a recording device. A comprehensive description of the prior art wobble in a writable CD system comprising disc control information encoded in such a manner can be found in U.S. Pat. No. 4,901,300 (PHN 12.398) and U.S. Pat. No. 5,187,699 (PHQ 88.002). Alternatively the wobble may be monotone (i.e. a periodic variation of a constant frequency) and additional elements are added to encode record carrier information, for example interruptions of the pregroove of modulation of the width. The Figure shows an example of such additional elements, i.e. prepits 18, 19 that are located in the land areas adjacent to the pregroove. The prepits may be located between two neighboring tracks, and are then detectable from both neighboring tracks. The radial modulation signal is modulated by the radial modulation of the track, in particular by the wobble and prepits. Prepits on both sides of the track are distinguishable by the polarity in the radial modulation signal. For example prepits are used in DVD-R and DVD-RW to encode record carrier information. The invention is particularly suitable for detecting so-called land-prepits (LPPs), which are part of the pregroove-format of DVD-R and DVD-RW media. An LPP is a ‘bridge’ between two adjacent grooves, which has a width of about two channel bits, and a depth equal to the depth of the pregroove itself. They are read by means of push-pull-detection (PP). The LPPs are intended for navigation and synchronisation on a blank or partly written disk.

FIG. 2 shows a recording device having prepit detection. The device is provided with means for scanning a track on a record carrier 11, which means include a drive unit 21 for rotating the record carrier 11, a head 22, a servo unit 25 for positioning the head 22 on the track and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for focusing the beam to the radiation spot on the track by moving the focus of the radiation beam 24 along the optical axis of said beam, and a tracking actuator for fine positioning of the spot 23 in a radial direction on the center of the track. The tracking actuator may comprise coils for radially moving an optical element or may alternatively be arranged for changing the angle of a reflecting element. For reading the radiation reflected by the information layer is detected by a detector of a usual type, e.g. a four-quadrant diode, in the head 22 for generating detector signals, including a main scanning signal 33 and sub-detector signals 35 for tracking and focusing. A front-end unit 31 is coupled to the head 22 for receiving the detector signals based on radiation reflected from the track, the detector signals including a left sub-detector signal and a right sub-detector signal based on the radiation as reflected from a left and right side of the track respectively. The sub-detector signals 35 are coupled to the servo unit 25 for controlling said tracking actuators. The main scanning signal 33 is processed by read processing unit 30 of a usual type including a demodulator, deformatter and output unit to retrieve the information.

The control unit 20 controls the recording and retrieving of information and may be arranged for receiving commands from a user or from a host computer. The control unit 20 is connected via control lines 26, e.g. a system bus, to the other units in the device. The control unit 20 comprises control circuitry, for example a microprocessor, a program memory and interfaces for performing the procedures and functions as described below. The control unit 20 may also be implemented as a state machine in logic circuits.

The device is provided with recording means for recording information on record carriers of a writable or re-writable type, for example CD-R, CD-RW, DVD-RW and/or BD (Blu-ray Disc). The recording means cooperate with the head 22 and front-end unit 31 for generating a write beam of radiation, and comprise write processing means for processing the input information to generate a write signal to drive the head 22, which write processing means comprise an input unit 27, a formatter 28 and a modulator 29. For writing information the power of the beam of radiation is controlled by modulator 29 to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of polarization different from their surroundings, obtained when recording in magneto-optical material. In an embodiment the recording power of the beam of radiation is adjusted by an optimum power control mechanism (OPC). The recording power may be adjusted under control of control unit 20 by reading marks recorded at different settings of the recording power via read unit 30, and subsequently detecting the optimum setting of the recording power.

In an embodiment the input unit 27 comprises compression means for input signals such as analog audio and/or video, or digital uncompressed audio/video. Suitable compression means are described for video in the MPEG standards, MPEG-1 is defined in ISO/IEC 11172 and MPEG-2 is defined in ISO/IEC 13818. The input signal may alternatively be already encoded according to such standards.

The device has a demodulation unit 32 detecting pregroove modulation in the detector signals and for retrieving record carrier information from the modulated pregroove. The sub-detector signals 35 from the front-end unit 31 are coupled to the demodulation unit 32. The demodulation unit includes a radial modulation signal circuit 34 for generating a radial modulation signal based on a difference signal of the sub-detector signals, e.g. on the push-pull signal based on the left detector signal (L) and the right detector signal (R). The difference signal is normalized by a sum signal of the sub-detector signals, e.g. the sum of the left detector signal and the right detector signal. Normalizing may be performed by dividing, or controlling a gain. For controlling the maximum ratio of said normalizing a correction signal is added to the sum signal, i.e. to prevent that that the difference signal is enlarged too much when the left and right sub-detector signals are very small. The correction amount may be determined during design or manufacture of the device, but preferably is adjusted in dependence of measurements performed on a record carrier, e.g. after inserting a record carrier in the device as explained below.

In an embodiment the radial modulation signal circuit 34 is arranged for generating the difference signal by adding a second correction signal. By adding the second correction amount to the difference signal the resulting radial modulation signal is controlled also at very small values of the left detector signal and the right detector signal, e.g. for controlling offset of the sub-detector signals.

FIG. 3 shows a radial modulation signal at a prepit. A pregroove 40 has neighboring pregrooves 45,46. A prepit 41 is shown as a bridge between the pregrooves. In the situation on the left a radial modulation signal 43 is shown for a track that does not contain recorded marks. In the situation on the right a radial modulation signal 44 is shown for a track that does contain a recorded mark 42. Clearly the radial modulation signal has significantly lower amplitude due to the presence of the mark 45. Hence the problem with prepit detection is that on a written area the radial modulation signal (PP) is severely disturbed by the written marks. If the LPP is located at the position of a land, the amplitude of the radial modulation signal due to the prepit (called LPP signal) will be high (left), but if it is located at the position of a mark (e.g. a recorded pit), the LPP amplitude will be low (right). Furthermore, the written marks cause noise in the PP-signal (not shown), which jeopardizes the detection of the peaks in the radial modulation signal due to the LPPs.

The radial modulation signal processing according to the invention improves the signal to noise ration (SNR) of the LPP signal on a written area by applying a normalization (dividing) operation, which is tuned by a correction amount to make the peaks more equal in amplitude. Because the DVD-R/RW format defines a rapid succession of LPPs, this operation has to be very fast. Hence wideband normalization is applied.

FIG. 4 shows a radial modulation signal in a written area. In horizontal direction the LPP signals along the tracks on a written area are shown. The effect of the normalization process is illustrated by an accurate simulation model to produce and process the signals as shown. The upper curve 51 shows a central aperture signal CA, i.e. a sum signal for detecting the recorded marks. The Central Aperture signal CA is based on a sequence of marks and lands. The second curve 52 shows a push-pull signal PP, i.e. a L−R push-pull signal for 5 equidistant LPPs next to the sequence of marks. The third curve 53 shows a normalized push-pull signal PPN, based on (L−R)/(L+R) sub-detector signals. Note that the normalized push-pull signal has some disturbing signal parts 55, which are not caused by a prepit but by overcompensation due to very small sub-detector signals. A fourth curve 54 shows a normalized and corrected push-pull signal PPN2, based on (L−R+Δ)/(L+R+Δ) normalized sub-detector signals, modified by a correction amount Δ for optimum detection margin. The disturbing signal parts 55 have been substantially reduced.

As is shown in the Figure, the LPP-peaks in PP vary enormously in amplitude due to the crosstalk from the marks. The variation is substantially reduced by applying normalization, i.e. PPN=(L−R)/(L+R). However, the normalization overcompensates the original differences between the peaks: in PP the LPP-peaks at marks are smaller than those at lands, but in PPN it's the other way around, although the variation is much reduced. By applying and tuning the parameter Δ in the radial modulation signal PPN2=(L−R+Δ)/(L+R+Δ), a much more equal amplitude is obtained, as is shown in the last trace 54. This corresponds with a substantial increase in SNR or detection margin.

In an embodiment the signal PPN2=(L−R+Δ₁)/(L+R+Δ₂), where two parameters Δ₁ and Δ₂ are tuned independently. As both correction values are tuned, the resulting radial modulation signal is controlled accurately.

FIG. 5 shows a circuit for generating a radial modulation signal. A left sub-detector signal L 61 and a left correction amount a 63 are coupled to an adder, and subsequently to a first input of a normalizing circuit NORM 65. A right sub-detector signal R 62 and a right correction amount a 64 are coupled to a second adder, and subsequently to a second input of the normalizing circuit 65. The normalizing circuit 65 has the function of normalizing by dividing a difference signal of both input with the sum signal: OUT=(IN₁−IN₂)/(IN₁+IN₂). Such multiplier circuits are well-known, e.g. a so-called Gilbert-cell in the analogue domain, as described in “A precise four-quadrant multiplier with subnanosecond response” by Gilbert, B, in: IEEE Journal of Solid-State Circuits, Publication Date: December 1968, on pages: 365-373, Volume: 3, Issue: 4, ISSN: 0018-9200. To the inputs offsets a and b are added, hence the resulting formula is OUT=(IN₁−IN₂+a−b)/(IN₁+IN₂+a+b), which is equivalent to PPN2=(L−R+Δ₁)/(L+R+Δ₂). Hence the offsets a and b result in Δ₁=a−b and Δ₂=a+b.

In an embodiment the control unit 20 is arranged for setting the first and/or second correction value based on a measurement of signals from the record carrier. An amount of encoded record carrier information is read from a part of the track that contains marks, while varying the correction amounts for determining an optimum of the radial modulation signal. For example tuning of values a and b is done by reading a number of so-called LPP-frames on a written area, while varying a and/or b, and determining the optimum radial modulation signal in terms of LPP-amplitude variation. An LPP-error rate, or LPP-sync error rate, may be determined to detect such an optimum.

In an embodiment the control unit 20 is arranged for performing the measurement after inserting a record carrier. In practice a recording process on a (dual-layer) DVD-R or DVD-RW disc proceeds as follows. First the drive detects insertion of a disc. After start-up procedures (e.g. Optimum Power Control OPC, an initial focus offset calibration at a test area, etc.) the drive jumps to a recorded area. If necessary (e.g. on a virgin disc) the drive first records some data, e.g. in a test area. Subsequently during reading the written area the LPP signal is monitored while varying the correction amount(s), and the optimum compensation is detected.

Although the invention has been mainly explained by embodiments using optical discs having a prepits for encoding record carrier information, the invention is also suitable for other record carriers such as rectangular optical cards, magneto-optical discs or any other type of information storage system that have a radially modulated preformed track pattern and retrieve record carrier information from detector signals that are affected by the marks. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for recording information on a record carrier (11) via a beam of radiation (24), the information being represented by marks in a track, the record carrier having a preformed track pattern for indicating the track, the preformed track pattern including a radial modulation pattern for encoding record carrier information, the device comprising
a control unit (20) for controlling the recording,
a head (22) for providing the beam of radiation for generating a scanning spot on the track,
a front-end unit (31) coupled to the head for generating detector signals based on radiation reflected from the track, the detector signals including a left sub-detector signal and a right sub-detector signal based on the radiation as reflected from a left and right side of the track respectively, and
demodulation means (32) for retrieving the record carrier information from the detector signals, the demodulation means comprising
radial modulation signal means (34) for generating a radial modulation signal based on a difference signal of the sub-detector signals normalized by a sum signal of the sub-detector signals, and for generating the sum signal by adding a first correction amount.

2. Device as claimed in claim 1, wherein the radial modulation signal means (34) is arranged for generating the difference signal by adding a second correction amount.

3. Device as claimed in claim 1, wherein the radial modulation signal means (34) is arranged for said normalizing by dividing the sum signal by the difference signal.

4. Device as claimed in claim 3, wherein the radial modulation signal means (34) is arranged for generating the radial modulation signal according to
(L−R+Δ₂)/(L+R+Δ₁), L being a left sub-detector signal, R being a right sub-detector signal, Δ₁ being the first correction amount and Δ₂ being the second correction amount.

5. Device as claimed in claim 1, wherein the control unit (20) is arranged for setting the first and/or second correction value based on a measurement of signals from the record carrier.

6. Device as claimed in claim 5, wherein the control unit (20) is arranged for performing the measurement after inserting a record carrier, in a particular case by reading an amount of encoded record carrier information from a part of the track that contains the marks, while varying the correction amounts for determining an optimum of the radial modulation signal.

7. Device as claimed in claim 1, wherein the radial modulation signal means (34) is arranged for generating the radial modulation signal based on the radial modulation pattern comprising prepits for encoding record carrier information.

8. Method of generating a radial modulation signal from a track on a record carrier, the track comprising marks representing information, the record carrier having a preformed track pattern for indicating the track, the preformed track pattern including a radial modulation pattern for encoding record carrier information, the method comprising
generating detector signals based on radiation reflected from the track, the detector signals including a left sub-detector signal and a right sub-detector signal based on the radiation as reflected from a left and right side of the track respectively, and
retrieving the record carrier information from the detector signals by
generating a radial modulation signal based on a difference of the sub-detector signals normalized by a sum of the sub-detector signals, and for generating the sum by adding a first correction amount.
